(19) United States
(12) Patent Application Publication
(10) Pub. No.: US 2023/0170615 A1
(43) Pub. Date: Jun. 1, 2023

(54) DUPLEXED BASE STATION ANTENNAS

(71) Applicant: CommScope Technologies LLC, Hickory, NC (US)

(72) Inventors: Mohamed Nadder Hamdy, Port Melbourne (AU); Giuseppe Resnati, Seregno (IT); John W. Brunner, Ramona, CA (US)

(21) Appl. No.: 17/998,056

(22) PCT Filed: May 10, 2021
(86) PCT No.: PCT/US2021/031488

§ 371 Date: Nov. 7, 2022

Related U.S. Application Data
(60) Provisional application No. 63/024,846, filed on May 14, 2020.

(51) Int. Cl. H01Q 5/307; H01Q 1/24; H01Q 3/34

(52) U.S. Cl. CPC H01Q 5/307; H01Q 1/246; H01Q 3/34

(57) ABSTRACT

Base station antennas are provided. A base station antenna includes a plurality of arrays of radiating elements. The antenna includes a downlink radio frequency (RF) feed network that is configured to filter downlink portions of different frequency bands and that couples the filtered downlink portions of the different frequency bands to the arrays. Moreover, the antenna includes an uplink RF feed network that couples uplink portions of the different frequency bands to the arrays and that is separate from the downlink RF feed network.

### CROSS-REFERENCE TO RELATED APPLICATION

The present application claims priority to U.S. Provisional Pat. Application No. 63/024,846, filed May 14, 2020, the entire content of which is incorporated herein by reference.

### FIELD

The present disclosure relates to communication systems and, in particular, to base station antennas.

### BACKGROUND

Base station antennas for wireless communication systems may include several ports for Radio Frequency (“RF”) signals. For example, base station antennas can use the ports to transmit downlink RF signals to, and receive uplink RF signals from, fixed and mobile users of a cellular communications service. Base station antennas often include a linear array or a two-dimensional array of radiating elements, such as dipole, or crossed-dipole, radiating elements that are coupled to the ports.

Example base station antennas are discussed in International Publication No. WO 2017/165512 to Bisiules and U.S. Pat. Application No. 15/921,694 to Bisiules et al., the disclosures of which are hereby incorporated herein by reference in their entireties. Though it may be advantageous for a base station antenna to communicate using multiple frequency bands, the use of multiple frequency bands can cause passive intermodulation (“PIM”) distortion and result in a complex design that undesirably increases antenna dimensions.

### SUMMARY

A base station antenna, according to some embodiments herein, may include a plurality of first frequency band ports. The base station antenna may include a plurality of second frequency band ports, the first frequency band being different from the second frequency band. The base station antenna may include a first duplexer that couples the first frequency band ports to a plurality of first downlink RF paths and a plurality of first uplink RF paths. The base station antenna may include a second duplexer that couples the second frequency band ports to a plurality of second downlink RF paths and a plurality of second uplink RF paths. The base station antenna may include a plurality of arrays of radiating elements. The base station antenna may include a first multiplexer that couples the first and second downlink RF paths to the arrays. Moreover, the base station antenna may include a second multiplexer that couples the first and second uplink RF paths to the arrays.

In some embodiments, the base station antenna may include a bandpass filter that is coupled to the first and second downlink RF paths. The bandpass filter may be integrated with the first multiplexer. The second multiplexer, by contrast, may not be integrated with any bandpass filter.

According to some embodiments, the bandpass filter may include: a first bandpass filter, for a downlink portion of the first frequency band, that is coupled between a first of the first downlink RF paths and the arrays; and a second bandpass filter, for an uplink portion of the first frequency band, that is coupled between a first load and the arrays. The first bandpass filter and the third bandpass filter may be at different levels, respectively, of a filter stack inside the base station antenna. The first load may be a resistive load. Moreover, the second bandpass filter and the first load may be configured to cancel a reflection of the uplink portion of the first frequency band.

The bandpass filter may include: a third bandpass filter, for the downlink portion of the first frequency band, that is coupled between a second of the first downlink RF paths and the arrays; a fourth bandpass filter, for the uplink portion of the first frequency band, that is coupled between a second load, or the first load, and the arrays; a fifth bandpass filter, for a downlink portion of the second frequency band, that is coupled between a first of the second downlink RF paths and the arrays; a sixth bandpass filter, for an uplink portion of the second frequency band, that is coupled between a third load, or the first load or the second load, and the arrays; a seventh bandpass filter, for the downlink portion of the second frequency band, that is coupled between a second of the second downlink RF paths and the arrays; and an eighth bandpass filter, for the uplink portion of the second frequency band, that is coupled between a fourth load, or the first load or the second load or the third load, and the arrays. Moreover, the base station antenna may include: a third bandpass filter, for the uplink portion of the first frequency band; a fourth bandpass filter, for the uplink portion of the second frequency band; and a common uplink port that is coupled between the arrays and the third and fourth bandpass filters.

In some embodiments, the base station antenna may include: a plurality of third frequency band ports, the third frequency band being different from the first and second frequency bands; and a third duplexer that couples the third frequency band ports to a plurality of third downlink RF paths and a plurality of third uplink RF paths. The first multiplexer may further couple the third downlink RF paths to the arrays, and the second multiplexer may further couple the third uplink RF paths to the arrays. Each of the first, second, and third frequency bands may include frequencies under 1 gigahertz (“GHz”).

According to some embodiments, the base station antenna may include: a plurality of first phase shifters that are coupled between the first multiplexer and the first and second downlink RF paths; and a plurality of second phase shifters that are coupled between the second multiplexer and the first and second uplink RF paths.

In some embodiments, the base station antenna may include: a first phase shifter that is coupled between the first multiplexer and the arrays; and a second phase shifter that is coupled between the second multiplexer and the arrays.

According to some embodiments, the radiating elements may include a plurality of downlink radiating elements that are concentric with a plurality of uplink radiating elements, respectively.

In some embodiments, the arrays may include a plurality of downlink-only arrays and a plurality of uplink-only arrays.

A base station antenna, according to some embodiments herein, may include a plurality of first frequency band ports. The base station antenna may include a plurality of second frequency band ports, the first frequency band being different from the second frequency band. The base station antenna may include a first duplexer that couples the first frequency band ports to a plurality of first downlink RF paths and a plurality of first uplink RF paths. The base station antenna may include a second duplexer that couples the second frequency band ports to a plurality of second downlink RF paths and a plurality of second uplink RF paths. The base station antenna may include an RF filter that is coupled to the first and second downlink RF paths. The base station antenna may include a plurality of arrays of radiating elements. The base station antenna may include a first multiplexer that couples the first and second downlink RF paths to the arrays. Moreover, the base station antenna may include a second multiplexer that couples the first and second uplink RF paths to the arrays.

In some embodiments, the RF filter may include a bandpass filter that is coupled to the first multiplexer.

A base station antenna, according to some embodiments herein, may include a plurality of arrays of radiating elements. The base station antenna may include a downlink RF feed network that is configured to filter downlink portions of different frequency bands and that couples the filtered downlink portions of the different frequency bands to the arrays. Moreover, the base station antenna may include an uplink RF feed network that couples uplink portions of the different frequency bands to the arrays and that is separate from the downlink RF feed network.

In some embodiments, the downlink and uplink RF feed networks may include downlink and uplink multiplexers, respectively.

According to some embodiments, the base station antenna may include: a plurality of ports of the different frequency bands; and a plurality of duplexers that are coupled between the ports and the multiplexers and are configured to separate the downlink portions of the different frequency bands from the uplink portions of the different frequency bands.

In some embodiments, the downlink RF feed network may include a bandpass filter.

A base station antenna, according to some embodiments herein, may include a plurality of downlink arrays of downlink radiating elements that are configured to transmit downlink RF signals in first and second frequency bands. Moreover, the base station antenna may include a plurality of uplink arrays of uplink radiating elements that are configured to receive uplink RF signals in the first and second frequency bands. The uplink arrays may overlap the downlink arrays.

In some embodiments, the downlink arrays may include a first vertical column that overlaps a second vertical column of the uplink arrays in a vertical direction. Moreover, a center point of the first vertical column may be spaced apart from a center point of the second vertical column by a distance in a horizontal direction that is smaller than a total width of a first of the uplink radiating elements in the horizontal direction.

According to some embodiments, a first of the uplink radiating elements may be concentric with a first of the downlink radiating elements. The first of the uplink radiating elements may be at a first level in a forward direction that is different from a second level of the first of the downlink radiating elements in the forward direction. The first of the uplink radiating elements may be a first crossed-dipole radiating element and the first of the downlink radiating elements may be a second crossed-dipole radiating element that is rotated relative to the first crossed-dipole radiating element. Moreover, the first of the uplink radiating elements may be longer than the first of the downlink radiating elements.

In some embodiments, the first and second frequency bands may each include frequencies under 1 GHz.

### BRIEF DESCRIPTION OF THE DRAWINGS

FIG. 1A is a front perspective view of a base station antenna, according to embodiments of the present inventive concepts.

FIG. 1B is a front perspective view of the base station antenna of FIG. 1A electrically connected to a radio.

FIG. 1C is a schematic block diagram of ports of the base station antenna of FIG. 1A electrically connected to ports of the radio of FIG. 1B.

FIG. 1D is a schematic block diagram of the filtered feed network of FIG. 1C.

FIGS. 1E and 1F are schematic block diagrams of phase shifters coupled to the multiplexers of FIG. 1D.

FIGS. 2A and 2B are example schematic front views of the base station antenna of FIG. 1A with the radome removed.

FIGS. 2C and 2D are example schematic front and side views, respectively, of a pair of concentric radiating elements, according to embodiments of the present inventive concepts.

FIG. 2E is another example schematic front view of radiating elements, according to embodiments of the present inventive concepts.

FIG. 2F is a further example schematic front view of a radiating element, according to embodiments of the present inventive concepts.

FIG. 2G is yet another example schematic front view of a radiating element, according to embodiments of the present inventive concepts.

FIG. 3 is a schematic block diagram of the RF filter of FIG. 1D.

FIG. 4 is a schematic view of the bottom end cap of FIG. 1A.

### DETAILED DESCRIPTION

Pursuant to embodiments of the present inventive concepts, base station antennas are provided that transmit and/or receive RF signals in multiple low frequency bands. It may be desirable to provide multiple-input, multiple-output (“MIMO”) for two or more low bands, especially in places where high frequency bands have limited availability, such as indoors or on cell edges. For example, it may be desirable to provide 4 ×4 MIMO at frequency division duplex (“FDD”) 700 megahertz (“MHz”) and 800 MHz. RF combining of such low bands, however, can cause PIM distortion, as can combining downlink and uplink portions of a frequency band on the same RF transmission path. As used herein, the terms “low band” and “low frequency band” may be used interchangeably. Moreover, though RF transmission paths of the bands may be isolated all the way to radiating elements of an antenna, doing so for four arrays of low-band radiating elements can be complex and may result in undesirably large antenna dimensions. As an example, exceeding a 50-centimeter (“cm”) width for four low-band arrays or adding two panels per sector may be impractical for most operators.

According to the present inventive concepts, however, a base station antenna may include an internal filtered feed network in which downlink RF signals are segregated from uplink RF signals. The feed network thus comprises separate downlink and uplink feed networks. This downlink/uplink segregation allows the use of bandpass filters in the downlink feed network to block PIM distortion. For example, bandpass filters can block third-order (“IM3”) PIM products that are generated in uplink frequency bands from downlink RF transmission paths.

In particular, the present inventive concepts may use duplexers to route remote radio unit (“RRU”) signals into distinct downlink and uplink RF transmission paths. Moreover, low-band radiating elements may be segregated into downlink-only and uplink-only arrays. Because segregated downlink and uplink arrays of low-band radiating elements may be isolated in frequency by an FDD duplex gap, the downlink and uplink radiating elements may be in relatively close proximity without compromising isolation. For example, four arrays of low-band radiating elements may be mounted in the space typically occupied by two conventional low-band arrays.

A downlink multiplexer and an uplink multiplexer may be coupled between the duplexers and the low-band arrays. Moreover, the downlink multiplexer may comprise the bandpass filters that block PIM distortion.

The present inventive concepts can thus use separate downlink and uplink feed networks to block PIM distortion and to achieve isolation that facilitates using a relatively small amount of space inside an antenna.

Example embodiments of the present inventive concepts will be described in greater detail with reference to the attached figures.

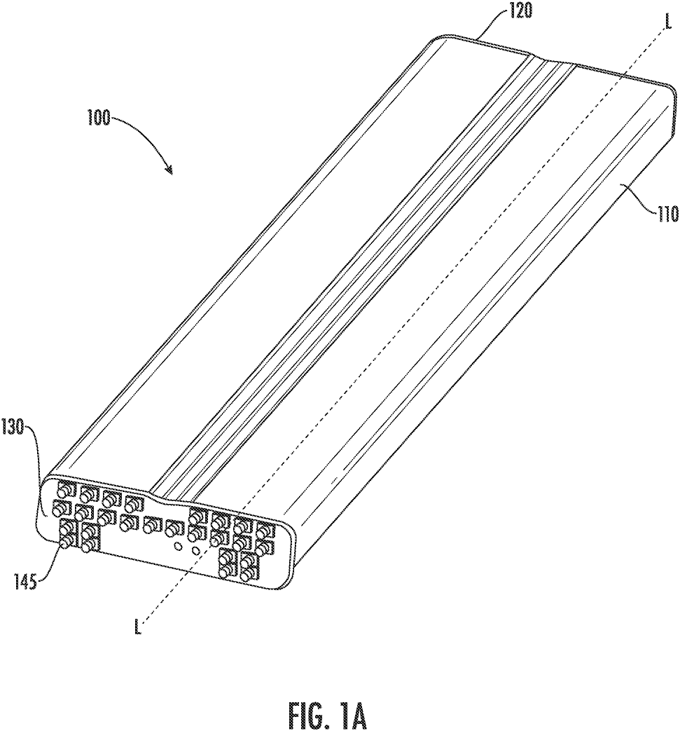

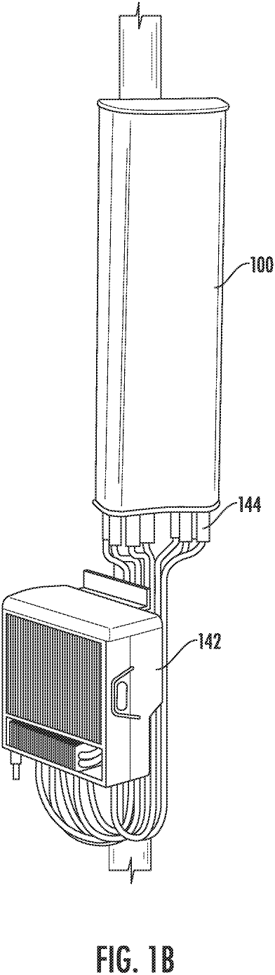

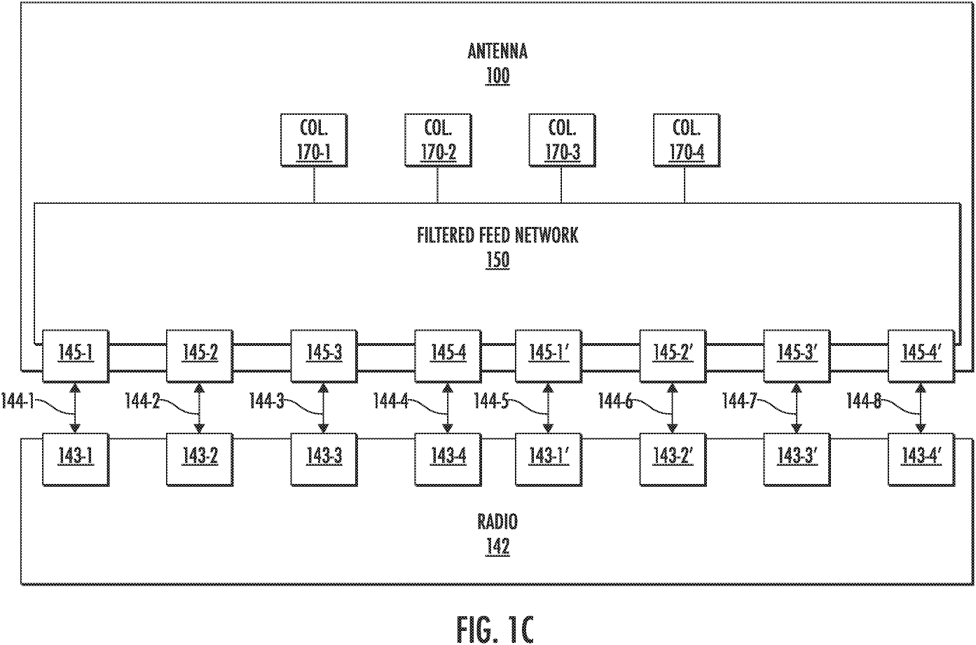

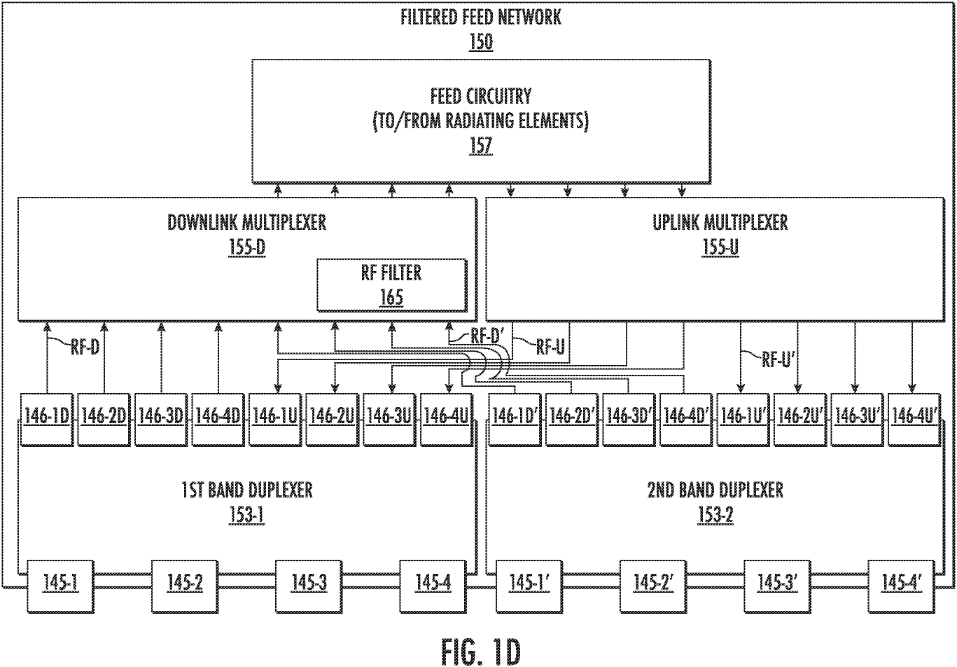

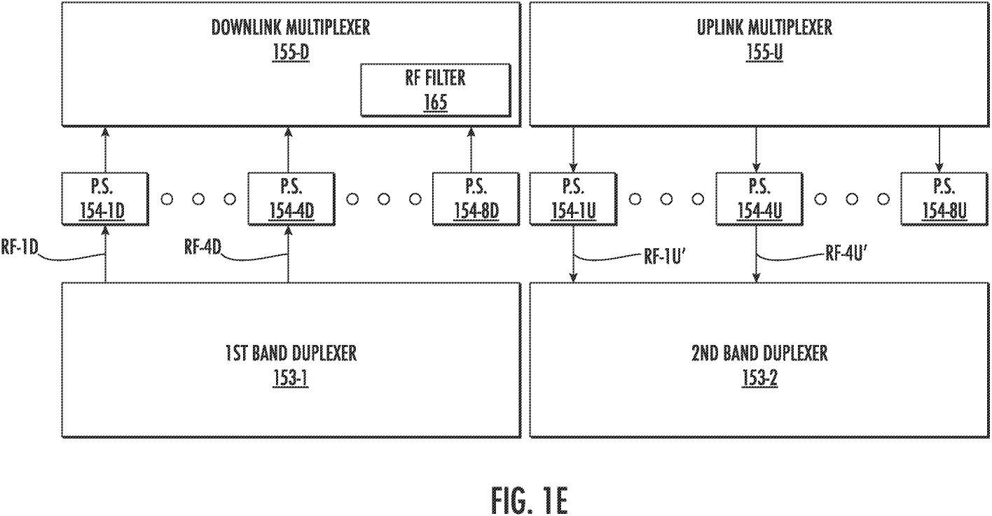

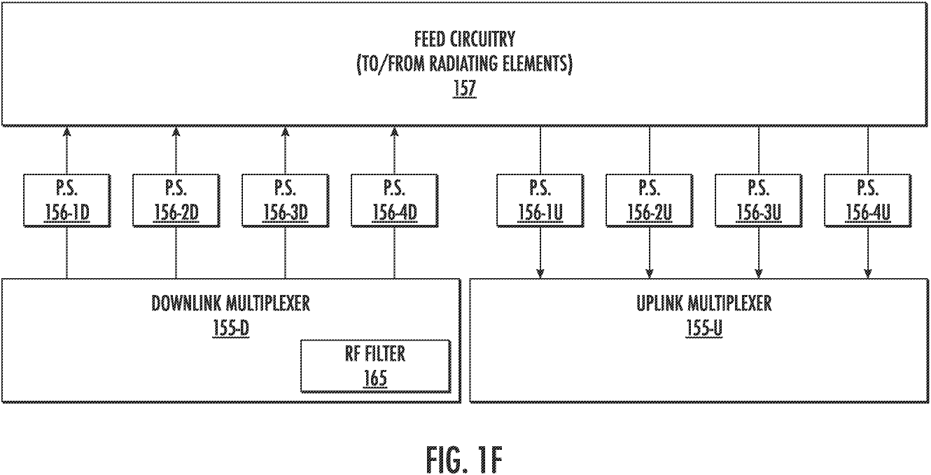

FIG. 1A is a front perspective view of a base station antenna 100, according to embodiments of the present inventive concepts. The antenna 100 may be, for example, a cellular base station antenna at a macrocell base station or at a small cell base station. As shown in FIG. 1A, the antenna 100 is an elongated structure and has a generally rectangular shape. The antenna 100 includes a radome 110. In some embodiments, the antenna 100 further includes a top end cap 120 and/or a bottom end cap 130. For example, the radome 110, in combination with the top end cap 120, may comprise a single unit, which may be helpful for waterproofing the antenna 100. The bottom end cap 130 is usually a separate piece and may include a plurality of RF connectors 145 mounted therein. The connectors 145, which may also be referred to herein as “ports,” are not limited, however, to being located on the bottom end cap 130. Rather, one or more of the connectors 145 may be provided on, for example, the rear (i.e., back) side of the radome 110 that is opposite the front side of the radome 110. The antenna 100 is typically mounted in a vertical configuration (i.e., the long side of the antenna 100 extends along a vertical axis L with respect to Earth).

FIG. 1B is a front perspective view of the base station antenna 100 electrically connected to a radio 142 by RF transmission lines 144, such as coaxial cables. For example, the radio 142 may be a cellular base station radio, and the antenna 100 and the radio 142 may be located at (e.g., may be components of) a cellular base station.

FIG. 1C is a schematic block diagram of ports 145 of the base station antenna 100 electrically connected to respective ports 143 of the radio 142. As shown in FIG. 1C, first frequency band ports 145-1 through 145-4 of the antenna 100 are electrically connected to first frequency band ports 143-1 through 143-4, respectively, of the radio 142 by respective RF transmission lines 144-1 through 144-4, such as coaxial cables. Similarly, second frequency band ports 145-1′ through 145-4′ of the antenna 100 are electrically connected to second frequency band ports 143-1′ through 143-4′, respectively, of the radio 142 by respective RF transmission lines 144-5 through 144-8. For simplicity of illustration, only eight ports 145 are shown in FIG. 1C. In some embodiments, however, the antenna 100 may include twelve, twenty, thirty, or more ports 145. Moreover, though all of the ports 143 are shown as being part of a single radio 142, it will be appreciated that the ports 143 may alternatively be spread across multiple radios 142.

The first and second frequency bands may be different respective low bands, such as bands that comprise 700 and 800 MHz, respectively. Accordingly, the antenna 100 may transmit and/or receive RF signals in at least two different low bands. Moreover, in some embodiments, the antenna 100 may transmit and/or receive RF signals in at least three different low bands (e.g., bands that comprise 700, 850, and 900 MHz, respectively), and thus may include ports 145 for each of the three or more low bands. For example, the antenna 100 may transmit and/or receive RF signals in five different low bands. In some embodiments, each low band may include a respective portion of a frequency range between 617 and 960 MHz. Each low band may thus comprise frequencies under 1,000 MHz (1 GHz).

The antenna 100 may include arrays (e.g., vertical columns) 170-1 through 170-4 of radiating elements that are configured to transmit and/or receive RF signals in the low bands. The antenna 100 may also include a filtered feed network 150 that is coupled between the arrays 170 and the radio 142. For example, the arrays 170 may be coupled to respective RF transmission paths of the network 150.

FIG. 1D is a schematic block diagram of the filtered feed network 150. As shown in FIG. 1D, the network 150 may include a plurality of duplexers 153 that are each coupled to a plurality of multiplexers 155. The term “duplexer” refers to a three-port filter that includes a first port that passes RF signals in a downlink portion of a frequency band, a second port that passes RF signals in an uplink portion of the frequency band, and a combined port that passes RF signals in both the uplink and downlink portions of the frequency band. Thus, a duplexer is a device that splits apart uplink and downlink signals that are fed into the duplexer at the combined port and passes the signals out of the respective uplink and downlink ports, and that combines uplink and downlink signals that are input at the respective uplink and downlink ports and passes the combined signals out of the combined port. Each duplexer 153 couples ports 145 of the antenna 100 to separate (a) downlink RF transmission paths RF-D, RF-D′ and (b) uplink RF transmission paths RF-U, RF-U′.

For example, a first duplexer 153-1 may couple four ports 145-1 through 145-4 of a first frequency band to four downlink paths RF-D, respectively, and four uplink paths RF-U, respectively. As an example, the duplexer 153-1 may have separate downlink ports 146-D and uplink ports 146-U that are coupled to the downlink paths RF-D and the uplink paths RF-U, respectively. In particular, the duplexer 153-1 may couple the port 145-1 to both a downlink port 146-1D and an uplink port 146-1U, which are coupled to a downlink path RF-D and an uplink path RF-U, respectively, of the first frequency band. The duplexer 153-1 may likewise (i) couple the port 145-2 to both a downlink port 146-2D and an uplink port 146-2U, (ii) couple the port 145-3 to both a downlink port 146-3D and an uplink port 146-3U, and (iii) couple the port 145-4 to both a downlink port 146-4D and an uplink port 146-4U.

A second duplexer 153-2 may operate with respect to a second frequency band analogously to how the first duplexer 153-1 operates with respect to the first frequency band. Accordingly, the duplexer 153-2 may couple four ports 145-1′ through 145-4′ of the second frequency band to separate (a) downlink ports 146-D′, respectively, and (b) uplink ports 146-U′, respectively. The downlink ports 146-D′ may be coupled to respective downlink paths RF-D′ of the second frequency band. Similarly, the uplink ports 146-U′ may be coupled to respective uplink paths RF-U′ of the second frequency band.

In some embodiments, the multiplexers 155 may comprise a downlink multiplexer 155-D and an uplink multiplexer 155-U. The multiplexer 155-D is coupled to each of the downlink paths RF-D, RF-D′ that provide downlink RF signals from the duplexers 153-1 and 153-2. The multiplexer 155-U, on the other hand, is coupled to each of the uplink paths RF-U that provide uplink RF signals to the duplexers 153-1 and 153-2. The multiplexers 155-D, 155-U, as well as the RF paths coupled thereto, may thus provide separate downlink and uplink RF feed networks, respectively.

The network 150 also includes an RF filter 165 that is coupled to the downlink paths RF-D, RF-D′. The filter 165 may comprise one or more bandpass filters, such as a vertical stack of bandpass filters. In some embodiments, the filter 165 may be integrated with the multiplexer 155-D. For example, the filter 165 and the multiplexer 155-D may be on the same printed circuit board (“PCB”), in the same vertical stack, and/or in the same enclosure inside the radome 110 (FIG. 1A). The multiplexer 155-U, however, may not be integrated with any bandpass filter, or may not be integrated with any vertical stack of bandpass filters. In some embodiments, the antenna 100 may not use any external RF filters.

Moreover, the network 150 may include feed circuitry 157 that couples filtered downlink RF signals from the multiplexer 155-D to downlink radiating elements that are in arrays 170 (FIG. 1C). The circuitry 157 may also couple uplink RF signals from uplink radiating elements that are in arrays 170 to the multiplexer 155-U. For example, the circuitry 157 may include power dividers, RF switches, RF couplers, and/or RF transmission paths that couple the multiplexers 155 to the arrays 170. In some embodiments, an RF filter may be coupled between the multiplexer 155-U and the circuitry 157.

For simplicity of illustration, FIG. 1D shows two duplexers 153 for two frequency bands, respectively, such as two low bands. In some embodiments, however, the network 150 may include three or more duplexers 153 for three or more frequency bands, respectively. Each duplexer 153 is coupled to both of the multiplexers 155. Accordingly, if the network 150 has three low-band duplexers 153, then each multiplexer 155 may be a triplexer.

The antenna 100 may also include phase shifters that are used to electronically adjust the tilt angle of the antenna beams generated by each array 170. The phase shifters may be located at any appropriate location along the RF transmission paths that extend between the ports 145 and the arrays 170. FIGS. 1E and 1F are schematic block diagrams of phase shifters coupled to the multiplexers 155. Accordingly, though omitted from view in FIG. 1D for simplicity of illustration, the filtered feed network 150 may include phase shifters. Separate phase shifters can be provided along downlink and uplink RF transmission paths, thus allowing the antenna 100 to independently control electronic tilt angles for downlink and uplink RF signals. This can also reduce the generation of PIM distortion.

For example, referring to FIG. 1E, phase shifters 154 may be coupled between the duplexers 153 and the multiplexers 155. As an example, first through eighth downlink phase shifters 154-1D through 154-8D may be coupled to respective RF transmission paths RF-D and RF-D′ (FIG. 1D) that provide downlink RF signals from the duplexers 153 to the downlink multiplexer 155-D. Likewise, first through eighth uplink phase shifters 154-1U through 154-8U may be coupled to respective RF transmission paths RF-U (FIG. 1D) and RF-U′ that provide uplink RF signals from the uplink multiplexer 155-U to the duplexers 153. Thus, a total of four phase shifters 154 may be provided for each array 170, namely a downlink phase shifter for each of two polarizations and an uplink phase shifter 154 for each of two polarizations.

For simplicity of illustration, downlink paths RF-D′ (FIG. 1D) of the second frequency band, as well as uplink paths RF-U (FIG. 1D) of the first frequency band, are omitted from view in FIG. 1E. Second, third, and fifth through seventh downlink phase shifters 154-2D, 154-3D, and 154-5D through 154-7D, as well as second, third, and fifth through seventh uplink phase shifters 154-2U, 154-3U, and 154-5U through 154-7U are also omitted from view in FIG. 1E.

Referring to FIG. 1F, as an alternative to coupling the phase shifters 154 (FIG. 1E) between the duplexers 153 (FIG. 1E) and the multiplexers 155, phase shifters 156 may be coupled between the multiplexers 155 and the feed circuitry 157. For example, first through fourth downlink phase shifters 156-1D through 156-4D may be coupled between the downlink multiplexer 155-D and the feed circuitry 157. Similarly, first through fourth uplink phase shifters 156-1U through 156-4U may be coupled between the uplink multiplexer 155-U and the feed circuitry 157. The arrangement of FIG. 1F requires only eight phase shifters, whereas the arrangement of FIG. 1E requires sixteen phase shifters. The arrangement of FIG. 1E, however, allows for independent tilt control of both frequency bands, while the arrangement of FIG. 1F requires the same amount of tilt to be applied to both frequency bands.

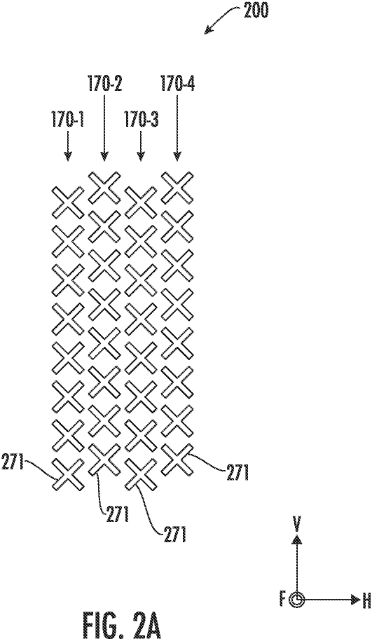

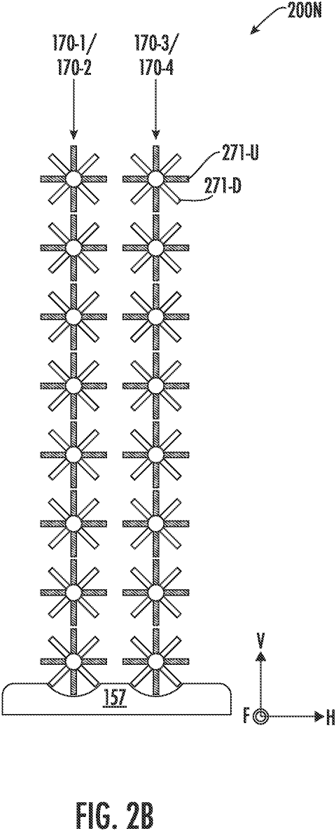

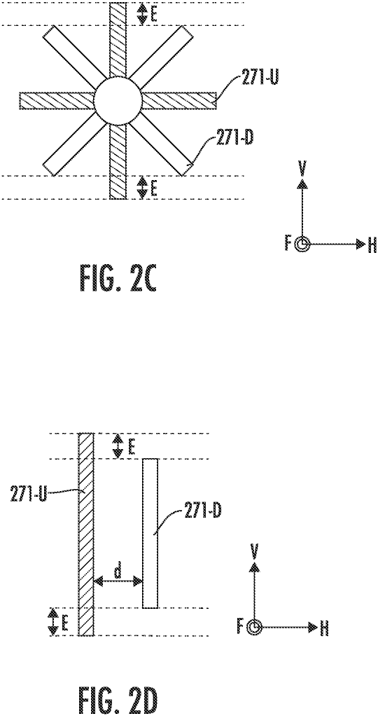

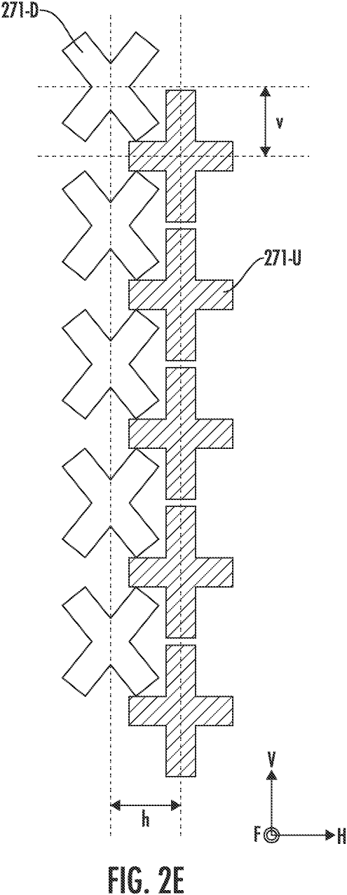

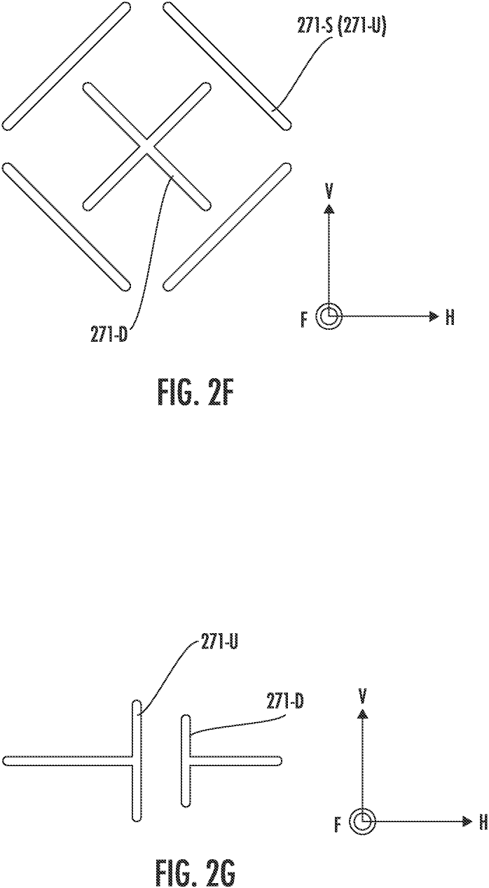

FIGS. 2A and 2B are example schematic front views of the base station antenna 100 of FIG. 1A with the radome 110 thereof removed to illustrate an antenna assembly of the antenna 100. The antenna assembly includes a plurality of radiating elements 271, which may be grouped into one or more arrays 170.

For example, FIG. 2A shows an antenna assembly 200 including four arrays 170-1 through 170-4 of radiating elements 271 in four vertical columns, respectively, that are spaced apart from each other in a horizontal direction H. Vertical columns of radiating elements 271 may extend in a vertical direction V from a lower portion of the antenna assembly 200 to an upper portion of the antenna assembly 200. The vertical direction V may be, or may be parallel with, the longitudinal axis L (FIG. 1A). The vertical direction V may also be perpendicular to the horizontal direction H and a forward direction F. As used herein, the term “vertical” does not necessarily require that something is exactly vertical (e.g., the antenna 100 may have a small mechanical down-tilt).

As another example, FIG. 2B shows a narrower antenna assembly 200N including four arrays 170-1 through 170-4 of radiating elements 271 in two vertical columns. Accordingly, the antenna assembly 200N may be approximately half the width (in the horizontal direction H) of the antenna assembly 200 (FIG. 2A). To achieve the narrower width of the antenna assembly 200N, radiating elements 271 of the array 170-1 may be concentric with radiating elements 271 of the array 170-2, and radiating elements 271 of the array 170-3 may be concentric with radiating elements 271 of the array 170-4. The array 170-1 thus overlaps the array 170-2 in the vertical direction V, and the array 170-3 likewise overlaps the array 170-4. For example, the array 170-1 may comprise downlink radiating elements 271-D that are concentric with uplink radiating elements 271-U of the array 170-2, and the array 170-3 may comprise downlink radiating elements 271-D that are concentric with uplink radiating elements 271-U of the array 170-4. Alternatively, the arrays 170-1 and 170-3 may comprise uplink radiating elements 271-U that are concentric with downlink radiating elements 271-D of the arrays 170-2 and 170-4, respectively.

In some embodiments, downlink radiating elements 271-D may be in arrays 170 that are independent of (e.g., separated from) arrays 170 that have uplink radiating elements 271-U. By dividing the arrays 170 into downlink-only and uplink-only arrays, adjacent ones of the arrays 170 may be isolated in frequency from each other by FDD duplex gaps, thus allowing downlink and uplink radiating elements 271-D, 271-U to be in close proximity without compromising isolation.

FIG. 2B also illustrates that a lower portion of the antenna assembly 200N may be adjacent the feed circuitry 157 that is coupled to the antenna assembly 200N. For example, the feed circuitry 157 may couple downlink-only arrays to the downlink multiplexer 155-D (FIG. 1D) and may couple uplink-only arrays to the uplink multiplexer 155-U (FIG. 1D). For simplicity of illustration, the feed circuitry 157 that is coupled to the antenna assembly 200 is omitted from view in FIG. 2A.

The radiating elements 271 shown in FIGS. 2A and 2B may extend forward in the forward direction F from one or more feeding (or “feed”) boards that couple RF signals to and from the individual radiating elements 271. For example, the radiating elements 271 may, in some embodiments, be on the same feeding board. As an example, the feeding board may be a single PCB having all of the radiating elements 271 thereon. Cables may be used to connect each feeding board to other components of the antenna 100, such as diplexers, phase shifters, or the like. In other embodiments, the feeding boards may be omitted and the radiating elements 271 may be connected by cables to other components of the antenna 100.

The arrays 170 are each configured to transmit low-band RF signals. The low-band signals may comprise signals in two, three, or more low frequency bands, such as bands in which all frequencies are below 1,400 MHz. Though FIGS. 2A and 2B illustrate four arrays 170-1 through 170-4, the antenna assembly 200 (or the narrower antenna assembly 200N) may include more (e.g., five, six, or more) or fewer (e.g., three, two, or one) arrays 170 that are configured to transmit low-band RF signals. Moreover, the number of radiating elements 271 in an array 170 can be any quantity from two to twenty or more. For example, the four arrays 170-1 through 170-4 shown in FIGS. 2A and 2B may each have five to twenty radiating elements 271. In some embodiments, the arrays 170 may each have the same number (e.g., eight) of radiating elements 271.

FIGS. 2C and 2D are example schematic front and side views, respectively, of a pair of concentric radiating elements 271, according to embodiments of the present inventive concepts. As shown in FIG. 2C, a downlink radiating element 271-D and an uplink radiating element 271-U may be respective crossed-dipole radiating elements that are concentric with each other. Accordingly, as the downlink radiating element 271-D may comprise two downlink dipoles and the uplink radiating element 271-U may comprise two uplink dipoles, the pair of concentric radiating elements 271 may collectively comprise four dipoles.

In some embodiments, the uplink radiating element 271-U may be larger than the downlink radiating element 271-D. For example, the uplink radiating element 271-U may have longer dipoles than the downlink radiating element 271-D. Accordingly, an upper portion of the uplink radiating element 271-U may extend farther by a distance E in the vertical direction V than an upper portion of the downlink radiating element 271-D. Likewise, a lower portion of the uplink radiating element 271-U may extend farther by the distance E in the vertical direction V than a lower portion of the downlink radiating element 271-D. The uplink radiating element 271-U may also extend farther in the horizontal direction H than the downlink radiating element 271-D.

As shown in FIG. 2D, a downlink radiating element 271-D and a uplink radiating element 271-U that are concentric with each other may be at different respective levels in the forward direction F. Specifically, the concentric radiating elements 271 may be spaced apart from each other by a distance d in the forward direction F.

Sufficient isolation between concentric downlink and uplink radiating elements 271-D, 271-U may be provided by an FDD duplex gap. Due to the nature of signal reflections and dynamic orientation of uplink radiating elements 271-U, a forty-five-degree polarization deviation may not negatively affect performance. In other words, the uplink radiating elements 271-U may each comprise a horizontally-polarized dipole and a vertically-polarized dipole, while the downlink radiating elements 271-D may each comprise a slant -45° polarized dipole and a slant +45° polarized dipole. Moreover, separating the concentric downlink and uplink radiating elements 271-D, 271-U in depth by the distance d can help to achieve an isolation target.

By using uplink and downlink segregation of the present inventive concepts, an isolation target may be relaxed relative to that of conventional base station antennas. For example, when using uplink-only and downlink-only arrays 170, the isolation target may be about 15 decibels (“dB”) between the downlink and uplink radiating elements 271-D, 271-U rather than about 28 dB. Further isolation techniques may be used to mitigate PIM cross coupling and to improve antenna efficiency.

FIG. 2E is another example schematic front view of radiating elements 271, according to embodiments of the present inventive concepts. Unlike the concentric radiating elements 271 that are shown in FIGS. 2C and 2D, FIG. 2E shows downlink radiating elements 271-D having respective center points that are spaced apart from respective center points of adjacent uplink radiating elements 271-U by (i) a distance h in the horizontal direction H and (ii) a distance v in the vertical direction V. The distance h may be smaller than (e.g., 50-75% of) a total width of an uplink radiating element 271-U in the horizontal direction H, and the distance v may be smaller than (e.g., 50-75% of) a total length of the uplink radiating element 271-U in the vertical direction V. As a result, the uplink radiating elements 271-U may overlap the downlink radiating elements 271-D in the vertical direction V.

In some embodiments, the downlink radiating elements 271-D shown in FIG. 2E may be in a first array 170 (FIG. 1C) and the uplink radiating elements 271-U may be in a second array 170 that is adjacent the first array 170. As an example, the first and second arrays may be adjacent arrays 170-1 and 170-2, respectively, or adjacent arrays 170-4 and 170-3, respectively. The respective center points of the downlink radiating elements 271-D in the first array 170 may be collinear in the vertical direction V, and the respective center points of the uplink radiating elements 271-U in the second array 170 may be collinear in the vertical direction V. The spacing provided by the distances v and h can advantageously improve isolation (e.g., make it easier to achieve an isolation target) between the adjacent arrays 170 relative to the concentric arrays 170 shown in the narrower antenna assembly 200N (FIG. 2B), while still facilitating a relatively small antenna assembly.

For simplicity of illustration, only two arrays 170 are shown in FIG. 2E. Additional arrays 170, and/or additional radiating elements 271 in the arrays 170, having the spacing provided by the distances v and h, however, may be provided in an antenna assembly. For example, an antenna assembly may include two or more pairs of arrays 170 having the spacing provided by the distances v and h, and each array 170 may include five, six, seven, eight, or more radiating elements 271.

The radiating elements 271 shown in FIG. 2E, like those shown in FIG. 2C, may be respective crossed-dipole radiating elements. Moreover, dipoles of the downlink radiating elements 271-D may be rotated in the H-V plane by approximately forty-five degrees relative to dipoles of the uplink radiating elements 271-U.

FIG. 2F is a further example schematic front view of a radiating element 271, according to embodiments of the present inventive concepts. As shown in FIG. 2F, one or more of the radiating elements 271 may be a box-dipole radiating element. For example, a plurality of uplink radiating elements 271-U may be respective box-dipole radiating elements, each having four segments 271-S that collectively provide a box/rectangular shape. In some embodiments, one pair of segments 271-S may provide horizontally-extending sides that are parallel to the horizontal direction H, and another pair of segments 271-S may provide vertically-extending sides that are parallel to the vertical direction V. Alternatively, the segments 271-S may define an acute angle relative to the horizontal direction H and the vertical direction V.

Each uplink radiating element 271-U comprising a box-dipole radiating element may, in some embodiments, define a box/rectangle around a respective downlink radiating element 271-D. For example, the downlink radiating element 271-D may be a non-box-dipole radiating element, such as a crossed-dipole radiating element or a slot/patch radiating element that has a low profile and thus may not significantly impact performance of the downlink radiating element 271-D. As another example, the downlink radiating element 271-D may be a box-dipole radiating element that is smaller than the uplink radiating element 271-U that defines a box/rectangle around it.

Moreover, in some embodiments, one or more of the radiating elements 271 may be a tripole radiating element. For example, a plurality of uplink radiating elements 271-U may be respective tripole radiating elements, and/or a plurality of downlink radiating elements 271-D may be respective tripole radiating elements. FIG. 2G is yet another example schematic front view of a radiating element 271, according to embodiments of the present inventive concepts. In particular, FIG. 2G shows a downlink radiating element 271-D and an uplink radiating element 271-U that are respective tripole radiating elements. In some embodiments, however, one of the tripole radiating elements shown in FIG. 2G may be replaced with another type of radiating element, such as a crossed-dipole radiating element. Moreover, a distance between respective center points (in the horizontal direction H) of the downlink and uplink radiating elements 271-D, 271-U (irrespective of whether one or both of them is a tripole radiating element) may be smaller than (e.g., 50-75% of) a total width of the uplink radiating element 271-U in the horizontal direction H.

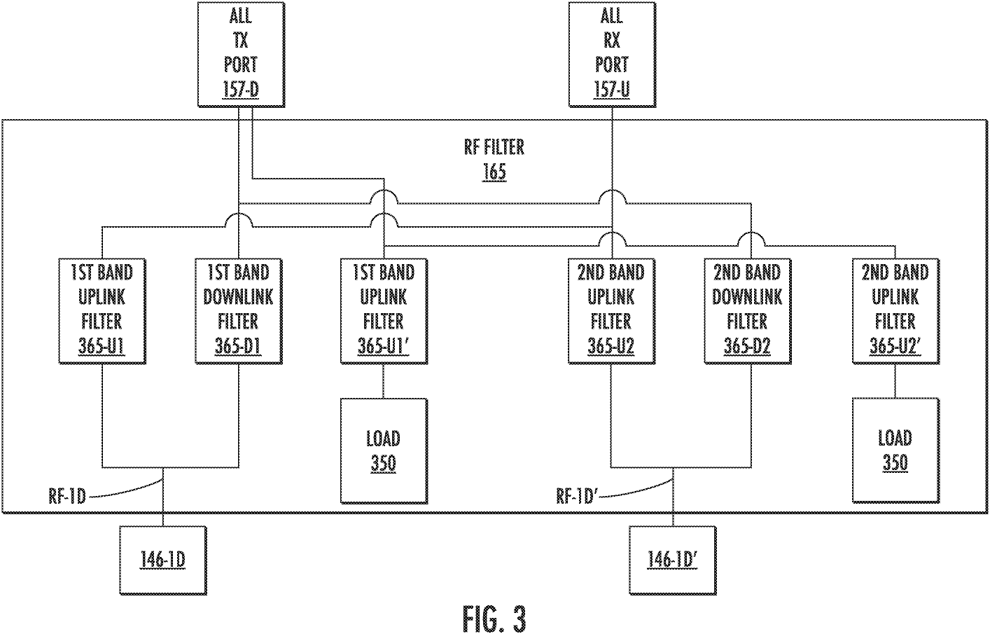

FIG. 3 is a schematic block diagram of the RF filter 165 of FIG. 1D. The filter 165 may include a plurality of bandpass filters 365. For example, a downlink bandpass filter 365-D1 that passes a downlink portion of the first frequency band may be coupled between a first-band downlink port 146-1D and arrays 170 (FIG. 1C) of radiating elements 271 (FIGS. 2A-2F) of a base station antenna 100 (FIG. 1A). An uplink bandpass filter 365-U1 that passes an uplink portion of the first frequency band may also be coupled between the port 146-1D and the arrays 170.

Moreover, an absorbing-branch bandpass filter 365-U1′ that passes the uplink portion of the first frequency band may be coupled between a load 350 and the arrays 170. The load 350 may comprise a resistive load, such as a fifty-ohm load, and the term “absorbing branch” may refer herein to an RF transmission path from a port 157-D to the load 350 via the filter 365-U1′. An absorbing branch comprising the filter 365-U1′ and the load 350 can advantageously help to absorb (e.g., cancel) PIM distortion that is caused by uplink RF signals that are reflected by the downlink bandpass filter 365-D1. For example, unwanted RF reflection can undesirably reduce a target amount of PIM mitigation by the antenna 100 by about 6 dB. Accordingly, by absorbing unwanted RF reflection, an absorbing branch of the filter 165 can improve PIM mitigation by about (e.g., at least) 6 dB.

The absorbing-branch bandpass filter 365-U1′ and the uplink bandpass filter 365-U1 may have the same passband, whereas the downlink bandpass filter 365-D1 may have a passband that is different from the passband of the absorbing-branch bandpass filter 365-U1′ and the uplink bandpass filter 365-U1. As an example, the absorbing-branch bandpass filter 365-U1′ and the uplink bandpass filter 365-U1 may each have a passband 703-733 MHz, and the downlink bandpass filter 365-D1 may have a passband of 758-788 MHz. The downlink and uplink portions of the first frequency band thus have a duplex gap (e.g., 25 MHz) therebetween.

As for the second frequency band, a downlink bandpass filter 365-D2 that passes a downlink portion of the second frequency band may be coupled between a second-band downlink port 146-1D′ and the arrays 170. The downlink ports 146-1D, 146-1D′ may be coupled to the downlink bandpass filters 365-D1, 365-D2 via respective downlink RF transmission paths RF-1D, RF-1D′. An uplink bandpass filter 365-U2 that passes an uplink portion of the second frequency band may also be coupled between the port 146-1D′ and the arrays 170. Moreover, an absorbing-branch bandpass filter 365-U2′ that passes the uplink portion of the second frequency band may be coupled between a load 350 and the arrays 170.

For simplicity of illustration, filters 365 are shown for one first-band downlink port 146-D and for one second-band downlink port 146-D′. These filters 365 may be at the same level among a plurality of vertical levels of filters 365 that are physically stacked inside the antenna 100. Additional filters 365 (e.g., at different vertical levels), however, may be provided for each first-band downlink port 146-D and for each second-band downlink port 146-D′. For example, referring again to FIG. 1D, first-band downlink ports 146-1D through 146-4D may each be coupled to a common downlink (i.e., transmit) port 157-D of the antenna 100 via respective first-band downlink bandpass filters 365-D1. Second-band downlink ports 146-1D′ through 146-4D′ (FIG. 1D) may likewise each be coupled to the common port 157-D via respective second-band downlink bandpass filters 365-D2. Moreover, absorbing-branch bandpass filters 365-U1′, 365-U2′ may also be coupled the common port 157-D. In particular, the absorbing-branch bandpass filters 365-U1′, 365-U2′ may each be coupled between a load 350 and the common port 157-D. Accordingly, by including the absorbing-branch bandpass filters 365-U1′, 365-U2′, the filter 165 can provide a reflection-less filter network in uplink frequency bands when measured from the common port 157-D.

A respective uplink bandpass filter 365-U1 may be coupled to each first-band downlink port 146-1D via a respective downlink RF path RF-D (FIG. 1D), and a respective uplink bandpass filter 365-U2 may be coupled to each second-band downlink port 146-1D′ via a respective downlink RF path RF-D′ (FIG. 1D). Also, a respective absorbing-branch bandpass filter 365-U1′ may absorb uplink RF signals that are reflected by each downlink bandpass filter 365-D1, and a respective absorbing-branch bandpass filter 365-U2′ may absorb uplink RF signals that are reflected by each bandpass filter 365-D2. Each uplink bandpass filter 365-U1 that is coupled to a downlink port 146-D, as well as each uplink bandpass filter 365-U2 that is coupled to a downlink port 146-D′, may be further coupled to a common uplink (i.e., receive) port 157-U of the antenna 100. The common ports 157-D, 157-U may be coupled to different arrays 170.

In some embodiments, the common ports 157-D, 157-U may be coupled to the arrays 170 via the same (i.e., a single common) cable. For example, though represented in FIG. 3 as two separate ports, the ports 157-D, 157-U may instead be a single combined port that is coupled to the cable.

Moreover, intersecting branches shown in FIG. 3 may be coupled to each other using, for example, transmission lines with proper impedance and electrical length. For example, the absorbing-branch bandpass filters 365-U1′, 365-U2′ may be commonly coupled to the port 157-D (and thus to downlink-filter branches) via respective transmission lines.

In some embodiments, a single (i.e., common) load 350 may be coupled to both absorbing-branch bandpass filters 365-U1′, 365-U2′ that are shown in FIG. 3. Such a single load 350 is not limited, however, to being coupled to two absorbing-branch bandpass filters 365-U′. Rather, the single load 350 may be coupled to three, four, or more (e.g., all) absorbing-branch bandpass filters 365-U′.

The bandpass filters 365 may not need coaxial jumper cables, and thus can be directly connected to a base plate (e.g., the bottom end cap 130 of FIG. 1A) of the antenna 100. Moreover, any of the filters 365 may be a five-pole bandpass filter or a six-pole bandpass filter.

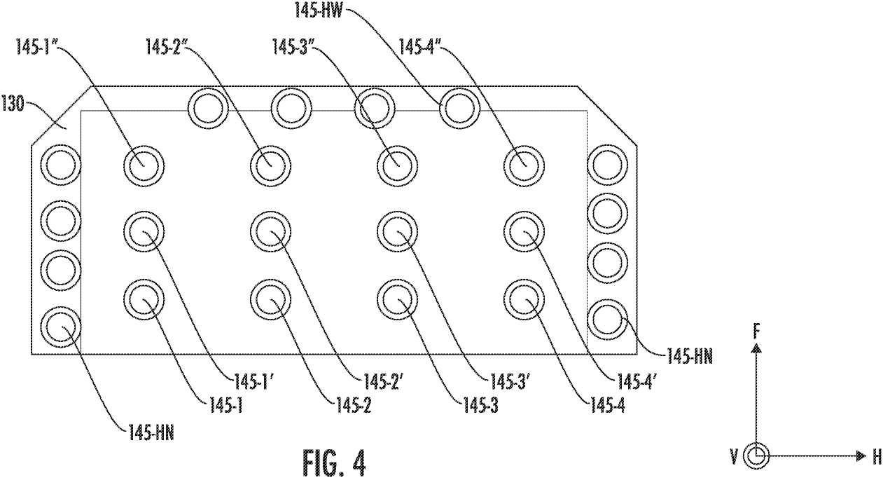

FIG. 4 is a schematic view of the bottom end cap 130 of FIG. 1A. As shown in FIG. 4, the end cap 130 may include various ports 145, including the first frequency band ports 145-1 through 145-4 and second frequency band ports 145-1′ through 145-4′ of FIG. 1C. The end cap 130 may also include third frequency band ports 145-1″ through 145-4″, where the first, second, and third frequency bands are different respective low frequency bands. Accordingly, the low-band ports 145-1″ through 145-4″ may, in some embodiments, also be coupled to the filtered feed network 150 (FIG. 1D). In particular, referring to FIGS. 1C and 1D, the low-band ports 145-1″ through 145-4″ may be coupled to the arrays 170 via a third-band duplexer 153 and the multiplexers 155-D and 155-U.

Moreover, the end cap 130 may include high-band ports 145-HW, 145-HN for one or more high frequency bands. For example, the ports 145-HW may be for a wider portion, such as 1,427 to 2,690 MHz, of a high frequency band, whereas the ports 145-HN may be for a narrower portion, such as 1,695 to 2,690 MHz, of the high frequency band. Referring again to FIG. 1C, the ports 145-HW, 145-HN of FIG. 4 may be coupled to arrays of radiating elements of the base station antenna 100 other than the arrays 170 that are coupled to the filtered feed network 150. For simplicity of illustration, twenty-four ports 145 are shown in FIG. 4, and they comprise the same number of high-band and low-band ports. In some embodiments, however, the antenna 100 may include more (e.g., sixteen, twenty, thirty, or more) or fewer (e.g., eight or ten) ports 145, and the ports 145 may not necessarily be divided equally between high-band and low-band ports.

The end cap 130 and the reflector of the antenna 100 may have a size that is 500 millimeters (“mm”) or smaller in the horizontal direction H and 200 mm or smaller in the forward direction F. For example, the dimensions may be 498 mm by 197 mm. In some embodiments, about 70 mm of the reflector in the horizontal direction H may be for the high-band ports 145-HN, and the remainder (about 430 mm) may be for low-band ports. Moreover, a face of the RF filter 165 shown in FIG. 3 may have dimensions of about 175 mm by 90 mm. As four ports 145 are provided in FIG. 4 for each of the three low frequency bands, four levels/layers of the filter 165 may be physically stacked inside the antenna 100 in the vertical direction V. Accordingly, bandpass filters 365 (FIG. 3) that are coupled to different respective ports 145 may be at different vertical levels, respectively, of a filter stack inside the antenna 100. Vertically stacking the filters 365 may facilitate better port 145 locations on the end cap 130. As an example, each level of the filter 165 may be coupled to a single column, in the forward direction F, of low-band ports on the end cap 130.

Base station antennas 100 (FIG. 1A) according to embodiments of the present inventive concepts may provide a number of advantages. These advantages include providing separate uplink and downlink RF transmission paths RF-D, RF-U (FIG. 1D) so that an RF filter 165 (FIG. 1D) can block PIM distortion in an uplink portion of a frequency band. For example, the filter 165 may include an absorbing-branch bandpass filter 365-U1′ (FIG. 3) that cancels a reflection of the uplink portion of the frequency band. In some embodiments, values of PIM distortion below -153 dB relative to the carrier (“dBc”) may be achievable because of the filter 165.

Moreover, referring to FIGS. 2B-2F, the advantages may include providing several (e.g., four) arrays 170 of radiating elements 271 in a small space to achieve a slim antenna 100. For example, the antenna 100 may include arrays 170 of downlink radiating elements 271-D that are isolated in frequency from arrays 170 of uplink radiating elements 271-U by FDD duplex gaps, thus allowing the downlink and uplink radiating elements 271-D, 271-U to be in relatively close proximity to each other without compromising isolation. As an example, a total width of the antenna 100 may not exceed 500 mm.

The present inventive concepts have been described above with reference to the accompanying drawings. The present inventive concepts are not limited to the illustrated embodiments. Rather, these embodiments are intended to fully and completely disclose the present inventive concepts to those skilled in this art. In the drawings, like numbers refer to like elements throughout. Thicknesses and dimensions of some components may be exaggerated for clarity.

Spatially relative terms, such as “under,” “below,” “lower,” “over,” “upper,” “top,” “bottom,” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the example term “under” can encompass both an orientation of over and under. The device may be otherwise oriented (rotated 90 degrees or at other orientations) and the spatially relative descriptors used herein interpreted accordingly.

Herein, the terms “attached,” “connected,” “interconnected,” “contacting,” “mounted,” and the like can mean either direct or indirect attachment or contact between elements, unless stated otherwise.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the present inventive concepts. As used herein, the singular forms “a,” “an,” and “the” are intended to include the plural forms as well, unless the context clearly indicates otherwise. It will be further understood that the terms “comprises,” “comprising,” “includes,” and/or “including” when used in this specification, specify the presence of stated features, operations, elements, and/or components, but do not preclude the presence or addition of one or more other features, operations, elements, components, and/or groups thereof.

1. A base station antenna comprising:
a plurality of first frequency band ports;
a plurality of second frequency band ports, the first frequency band being different from the second frequency band;
a first duplexer that couples the first frequency band ports to a plurality of first downlink radio frequency (RF) paths and a plurality of first uplink RF paths;
a second duplexer that couples the second frequency band ports to a plurality of second downlink RF paths and a plurality of second uplink RF paths;
a plurality of arrays of radiating elements;
a first multiplexer that couples the first and second downlink RF paths to the arrays; and
a second multiplexer that couples the first and second uplink RF paths to the arrays.

2. The base station antenna of claim 1, further comprising a bandpass filter that is coupled to the first and second downlink RF paths.

3. The base station antenna of claim 2, wherein the bandpass filter is integrated with the first multiplexer.

4. The base station antenna of claim 3, wherein the second multiplexer is not integrated with any bandpass filter.

5. The base station antenna of claim 2, wherein the bandpass filter comprises:
a first bandpass filter, for a downlink portion of the first frequency band, that is coupled between a first of the first downlink RF paths and the arrays; and
a second bandpass filter, for an uplink portion of the first frequency band, that is coupled between a first load and the arrays.

6. The base station antenna of claim 5, wherein the bandpass filter further comprises:
a third bandpass filter, for the downlink portion of the first frequency band, that is coupled between a second of the first downlink RF paths and the arrays;
a fourth bandpass filter, for the uplink portion of the first frequency band, that is coupled between a second load, or the first load, and the arrays;
a fifth bandpass filter, for a downlink portion of the second frequency band, that is coupled between a first of the second downlink RF paths and the arrays;
a sixth bandpass filter, for an uplink portion of the second frequency band, that is coupled between a third load, or the first load or the second load, and the arrays;
a seventh bandpass filter, for the downlink portion of the second frequency band, that is coupled between a second of the second downlink RF paths and the arrays; and
an eighth bandpass filter, for the uplink portion of the second frequency band, that is coupled between a fourth load, or the first load or the second load or the third load, and the arrays.

7. The base station antenna of claim 6, wherein the first bandpass filter and the third bandpass filter are at different levels, respectively, of a filter stack inside the base station antenna.

8. The base station antenna of claim 5, wherein the first load comprises a resistive load.

9. The base station antenna of claim 5, wherein the second bandpass filter and the first load are configured to cancel a reflection of the uplink portion of the first frequency band.

10. The base station antenna of claim 5, further comprising:
a third bandpass filter, for the uplink portion of the first frequency band;
a fourth bandpass filter, for the uplink portion of the second frequency band; and
a common uplink port that is coupled between the arrays and the third and fourth bandpass filters.

11. The base station antenna of claim 1, further comprising:
a plurality of third frequency band ports, the third frequency band being different from the first and second frequency bands; and
a third duplexer that couples the third frequency band ports to a plurality of third downlink RF paths and a plurality of third uplink RF paths,
wherein the first multiplexer further couples the third downlink RF paths to the arrays, and
wherein the second multiplexer further couples the third uplink RF paths to the arrays.

12. The base station antenna of claim 11, wherein each of the first, second, and third frequency bands comprises frequencies under 1 gigahertz (GHz).

13. The base station antenna of claim 1, further comprising:
a plurality of first phase shifters that are coupled between the first multiplexer and the first and second downlink RF paths; and
a plurality of second phase shifters that are coupled between the second multiplexer and the first and second uplink RF paths.

14. The base station antenna of claim 1, further comprising:
a first phase shifter that is coupled between the first multiplexer and the arrays; and
a second phase shifter that is coupled between the second multiplexer and the arrays.

15. The base station antenna of claim 1, wherein the radiating elements comprise a plurality of downlink radiating elements that are concentric with a plurality of uplink radiating elements, respectively.

16. The base station antenna of claim 1, wherein the arrays comprise a plurality of downlink-only arrays and a plurality of uplink-only arrays.

17. A base station antenna comprising:
a plurality of first frequency band ports;
a plurality of second frequency band ports, the first frequency band being different from the second frequency band;
a first duplexer that couples the first frequency band ports to a plurality of first downlink radio frequency (RF) paths and a plurality of first uplink RF paths;
a second duplexer that couples the second frequency band ports to a plurality of second downlink RF paths and a plurality of second uplink RF paths;
an RF filter that is coupled to the first and second downlink RF paths;
a plurality of arrays of radiating elements;
a first multiplexer that couples the first and second downlink RF paths to the arrays; and
a second multiplexer that couples the first and second uplink RF paths to the arrays.

18. (canceled)

19. A base station antenna comprising:
a plurality of arrays of radiating elements;
a downlink radio frequency (RF) feed network that is configured to filter downlink portions of different frequency bands and that couples the filtered downlink portions of the different frequency bands to the arrays; and
an uplink RF feed network that couples uplink portions of the different frequency bands to the arrays and that is separate from the downlink RF feed network.

20. The base station antenna of claim 19, wherein the downlink and uplink RF feed networks comprise downlink and uplink multiplexers, respectively.

21. The base station antenna of claim 20, further comprising:
a plurality of ports of the different frequency bands; and
a plurality of duplexers that are coupled between the ports and the multiplexers and are configured to separate the downlink portions of the different frequency bands from the uplink portions of the different frequency bands.

22-30. (canceled)
